(19) United States
(12) Patent Application Publication
(10) Pub. No.: US 2026/0105541 A1
(43) Pub. Date: Apr. 16, 2026

(54) ENERGY PREDICTION DEVICE AND ENERGY PREDICTION METHOD

(71) Applicants: Hyundai Motor Company, Seoul (KR); Kia Corporation, Seoul (KR); Gwangju Institute of Science and Technology, Gwangju (KR)

(72) Inventors: Jaehyuk CHOI, Hwaseong-si (KR); Euiseok HWANG, Gwangju (KR); Dongju KIM, Gwangju (KR)

(73) Assignees: Hyundai Motor Company, Seoul (KR); Kia Corporation, Seoul (KR); Gwangju Institute of Science and Technology, Gwangju (KR)

(21) Appl. No.: 18/965,782

(22) Filed: Dec. 2, 2024

(30) Foreign Application Priority Data
Oct. 15, 2024 (KR) 10-2024-0140082

(51) Int. Cl. G06Q 50/06; G06F 18/2415; G06Q 30/0202

(52) U.S. Cl. CPC G06Q 50/06; G06F 18/2415; G06Q 30/0202

(57) ABSTRACT

An energy prediction device includes: a clustering unit clustering energy consumers with similar energy consumption patterns; a training unit generating an energy prediction model through machine learning based on energy consumption data of the energy consumers in each cluster; and a prediction unit predicting an energy consumption amount by use of the energy prediction model.

### CROSS-REFERENCE TO RELATED APPLICATION

The present application claims priority to Korean Patent Application No. 10-2024-0140082 filed on Oct. 15, 2024, the entire contents of which is incorporated herein for all purposes by this reference.

### BACKGROUND OF THE PRESENT DISCLOSURE

### Field of the Present Disclosure

The present disclosure relates to an energy prediction device and an energy prediction method, and more particularly, to an energy prediction device and an energy prediction method for predicting an energy consumption amount of a large-scale energy consumption complex by use of a multiple period clustering technique.

### Description of Related Art

Individual energy consumers in a large-scale energy consumption complex share the same environmental variables such as weather information, and exhibit similar responses to various events affecting the energy consumption amount in an area of the energy consumption complex.

Among the events, daytype, which is information that significantly affects the energy consumption amount, is mostly the same as weekends and national holidays, but there may be daytype for a specific energy consumption complex, and in a case where an energy consumption prediction model is trained without such information, it is highly likely to include a negative impact on the prediction model.

Furthermore, current machine learning models have a problem in that energy prediction is inaccurate when learning data is insufficient.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an energy prediction device and an energy prediction method configured for predicting an energy consumption amount of an energy consumer corresponding to a cluster by training an energy prediction model for the cluster based on a classified weekly energy consumption pattern and daytype.

The present disclosure attempts to provide an energy prediction device and an energy prediction method configured for clustering energy consumers with similar weekly energy consumption patterns within the same energy consumption complex, extracting a daily energy consumption pattern to classify daytype, and predicting an energy consumption amount through an energy prediction model trained based on the classified weekly energy consumption pattern and daytype.

According to an exemplary embodiment of the present disclosure, an energy prediction device includes: a clustering unit clustering energy consumers with similar energy consumption patterns; a training unit generating an energy prediction model through machine learning based on energy consumption data of the energy consumers in each cluster; and a prediction unit predicting an energy consumption amount by use of the energy prediction model.

The clustering unit may cluster the energy consumers based on a measured similarity by extracting weekly period energy consumption patterns of energy consumers and measuring the similarity between the extracted weekly period energy consumption patterns.

The training unit may classify daily energy consumption patterns of the energy consumers in each cluster, distinguish between a holiday energy consumption pattern and a weekday energy consumption pattern, and train the energy prediction model based on the classified daily energy consumption patterns.

The training unit may train the energy prediction model based on individual energy consumption data of the energy consumers and the daily energy consumption patterns of the energy consumers in the same cluster.

The training unit may standardize the daily energy consumption patterns by use of a standardization technique to simultaneously consider the energy consumers with different energy consumption scales in the same cluster.

The energy prediction model may include a support vector regression (SVR) model, an artificial neural network multi-layer perceptron (MLP) model, and a stacked (Light-GBM-XGBoost-MLP Stacked) model.

The clustering unit may use an Akaike information criterion (AIC) to set the optimal number of clusters.

The energy prediction device may further include a preprocessing unit extracting abnormal data which is uncommon for energy consumption data, generating an index of each of a day and a week including the extracted abnormal data, and excluding the day and the week including the indices from the clustering and training.

According to an exemplary embodiment of the present disclosure, an energy prediction method includes: clustering energy consumers with similar energy consumption patterns; generating an energy prediction model through machine learning based on energy consumption data of the energy consumers in each cluster; and predicting an energy consumption amount by use of the energy prediction model.

The clustering may further include clustering the energy consumers based on a measured similarity by extracting weekly period energy consumption patterns of energy consumers and measuring the similarity between the extracted weekly period energy consumption patterns.

The generating of the energy prediction model may further include classifying daily energy consumption patterns of the energy consumers in each cluster, distinguishing between a holiday energy consumption pattern and a weekday energy consumption pattern, and training the energy prediction model based on the classified daily energy consumption patterns.

The training of the energy prediction model may further include training the energy prediction model based on the energy consumption data of the individual energy consumers and the daily energy consumption patterns of the energy consumers in the same cluster.

The training of the energy prediction model may further include standardizing the daily energy consumption patterns by use of a standardization technique to simultaneously consider the energy consumers with different energy consumption scales in the same cluster.

The training of the energy prediction model may further include training the energy prediction model by use of at least one of a support vector regression (SVR) model, an artificial neural network multi-layer perceptron (MLP) model, or a stacked (Light-GBM-XGBoost-MLP Stacked) model.

The clustering may further include using an Akaike information criterion (AIC) to set the optimal number of clusters.

The energy prediction method may further include performing preprocessing of extracting abnormal data which is uncommon for energy consumption data, generating an index of each of a day and a week including the extracted abnormal data, and excluding the day and the week including the indices from the clustering and the training.

With the energy prediction device and the energy prediction method according to an exemplary embodiment of the present disclosure, it is possible to predict an energy consumption amount of an energy consumer corresponding to a cluster by training an energy prediction model for the cluster based on a classified weekly energy consumption pattern and daytype.

With the energy prediction device and the energy prediction method according to an exemplary embodiment of the present disclosure, it is possible to simultaneously consider daily and weekly periods and classify daytype of energy consumption from a data perspective, effectively predicting an energy consumption amount even for an energy consumer whose energy consumption amount data is insufficient.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 schematically shows an energy prediction system according to an exemplary embodiment of the present disclosure;

FIG. 2 is a block diagram of an energy prediction device according to an exemplary embodiment of the present disclosure;

FIG. 3 is a flowchart of an energy prediction method according to an exemplary embodiment of the present disclosure;

FIG. 4 is a sequence diagram of the energy prediction method according to an exemplary embodiment of the present disclosure;

FIG. 5 shows graphs showing a clustering result according to an exemplary embodiment of the present disclosure;

FIG. 6 and FIG. 7 are graphs showing prediction results obtained using the energy prediction method according to an exemplary embodiment of the present disclosure; and

FIG. 8 is a diagram for describing a computing device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described more fully with reference to the accompanying drawings to be easily practiced by those skilled in the art to which the present disclosure pertains. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the present specification and the claims, unless explicitly described to the contrary, the word “comprise” and variations such as “comprises” or “comprising”, will be understood to imply the inclusion of stated elements but not the exclusion of any other elements. Terms including an ordinal number such as first and second may be used to describe various components, but these components are not limited by these terms. These terms are used only for distinguishing one component from another component.

Terms such as “-unit”, “-er/or”, and “module” described in the specification refer to a unit which may process at least one function or operation described in the present specification, and may be implemented as hardware or circuitry, software, or a combination of hardware or circuitry and software.

Hereinafter, various exemplary embodiments of the present disclosure will be described with reference to the accompanying drawings.

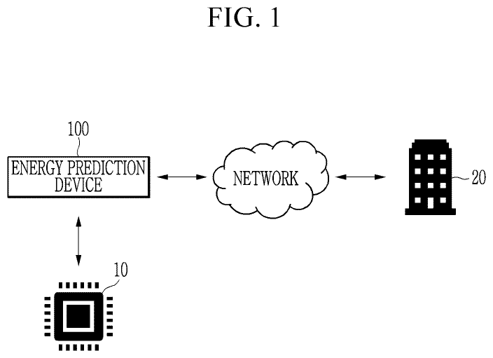

FIG. 1 schematically shows an energy prediction system according to an exemplary embodiment of the present disclosure.

Referring to FIG. 1, the energy prediction system may include an energy prediction device 100, an energy consumption complex 20, and an artificial intelligence model 10.

The energy prediction device 100 and the energy consumption complex 20 may be connected through a network. That is, the energy prediction device 100 and the energy consumption complex 20 may exchange data with each other through the network.

The energy consumption complex 20 may include a large-scale energy consumption complex. For example, the large-scale energy consumption complex may include an apartment complex and a commercial complex.

The energy prediction device 100 may perform energy prediction for an energy consumer in the large-scale energy consumption complex.

The energy prediction device 100 may be configured to generate the energy prediction model 10 by training the artificial intelligence model 10 based on energy consumption data received from the energy consumption complex 20 and may be configured to predict an energy consumption amount of the energy consumption complex 20 through the generated energy prediction model 10.

The energy prediction device 100 may be configured to predict an energy consumption amount of an individual energy consumer in the energy consumption complex 20 by use of a multiple period clustering technique.

The multiple period clustering technique is a clustering technique for finding patterns with various periodicities in time series data. With the multiple period clustering technique, it is possible to form clusters and find patterns in data by simultaneously considering multiple periods.

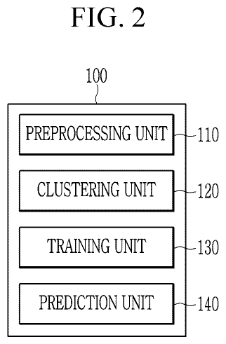

FIG. 2 is a block diagram of the energy prediction device according to an exemplary embodiment of the present disclosure.

Referring to FIG. 2, the energy prediction device 100 may include a preprocessing unit 110, a clustering unit 120, a training unit 130, and a prediction unit 140.

Herein, in an exemplary embodiment of the present disclosure, the preprocessing unit 110, the clustering unit 120, the training unit 130, and the prediction unit 140 may be implemented as separate processors. Alternatively, the preprocessing unit 110, the clustering unit 120, the training unit 130, and the prediction unit 140 may be implemented as a single integrated processor.

The preprocessing unit 110 may preprocess the energy consumption data received from the energy consumption complex 20.

The preprocessing unit 110 may select the energy consumption data and perform standardization through preprocessing.

The preprocessing unit 110 may extract abnormal data which is normally uncommon for the energy consumption data, and generate an index of each of a day and a week including the extracted abnormal data.

The preprocessing unit 110 may exclude a day and a week including the corresponding indices. That is, the preprocessing unit 110 may exclude the day and the week including the corresponding indices from a process of clustering the energy consumers and a process of training the energy prediction model.

The clustering unit 120 may cluster the energy consumers with similar energy consumption patterns.

The clustering unit 120 may extract weekly energy consumption patterns of the energy consumers based on the energy consumption data received from the energy consumption complex.

The clustering unit 120 may measure a similarity between the extracted weekly energy consumption patterns and cluster the energy consumers with similar weekly energy consumption patterns into one cluster based on the measured similarity.

The clustering unit 120 may be configured to generate a plurality of clusters. The clustering unit 120 may utilize an Akaike information criterion (AIC), which is one of cluster validity indices (CVI), to set the optimal number of clusters.

The training unit 130 may be configured to generate the energy prediction model 10 (see FIG. 1) through machine learning based on the energy consumption data of the energy consumers for each cluster.

The energy prediction model 10 may be generated through a support vector regression (SVR) model, an artificial neural network multi-layer perceptron (MLP) model, or a stacked (Light-GBM-XGBoost-MLP Stacked) model.

The training unit 130 may classify daily energy consumption patterns based on the energy consumption data of the energy consumers in each cluster.

The training unit 130 may distinguish between a holiday energy consumption pattern and a weekday energy consumption pattern in the classified daily energy consumption patterns.

The training unit 130 may train the energy prediction model 10 by use of the daily energy consumption patterns in which the holiday energy consumption pattern and the weekday energy consumption pattern are distinguished from each other.

The training unit 130 may train the energy prediction model 10 based on the energy consumption data of the individual energy consumers and the daily energy consumption patterns of the energy consumers in the same cluster.

The training unit 130 may standardize the daily energy consumption patterns by use of a standardization technique to simultaneously consider the energy consumers with different energy consumption scales in the same cluster.

The prediction unit 140 may be configured to predict the energy consumption amounts of the energy consumers by use of the trained energy prediction model 10.

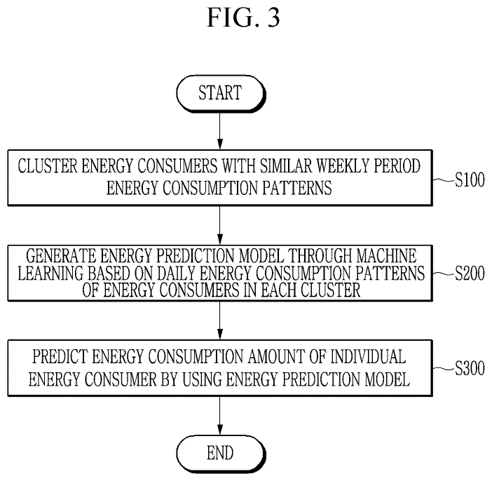

FIG. 3 is a flowchart of an energy prediction method according to an exemplary embodiment of the present disclosure. The energy prediction method of FIG. 3 may be performed by the energy prediction device 100 as shown in FIG. 2.

The energy prediction device 100 may extract the energy consumption pattern based on the energy consumption data. The energy prediction device 100 may extract each of a weekly period energy consumption pattern and a daily period energy consumption pattern (or the daily energy consumption pattern).

The energy prediction device 100 may be configured to predict the energy consumption amount using the trained energy prediction model by simultaneously considering the extracted daily period energy consumption pattern and weekly period energy consumption pattern.

In FIG. 3, the energy prediction device 100 may cluster the energy consumers with similar weekly period energy consumption patterns (step S100).

The energy prediction device 100 may be configured to generate the energy prediction model through machine learning based on the daily energy consumption patterns of the energy consumers in each cluster (step S200).

The energy prediction device 100 may be configured to predict the energy consumption amount of the individual energy consumer by use of the energy prediction model (step S300).

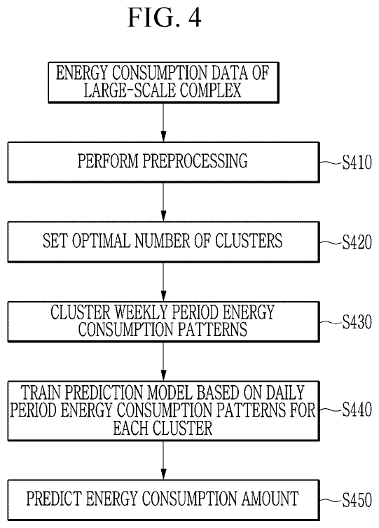

FIG. 4 is a sequence diagram of the energy prediction method according to an exemplary embodiment of the present disclosure. The energy prediction method may be performed by the energy prediction device 100 as shown in FIG. 2.

In FIG. 4, the energy prediction device 100 is configured to perform preprocessing when the energy consumption data is received from the large-scale energy consumption complex (step S410).

The energy prediction device 100 may perform data selection to exclude the abnormal data through the preprocessing.

That is, the energy prediction device 100 may find the abnormal data which is uncommon for the energy consumption data, generate the indices of a day and a week including the abnormal data, and exclude the day and the week including the corresponding indices before the clustering and training.

The energy prediction device 100 may perform standardization by use of the energy consumption data through the preprocessing.

The energy prediction device 100 may grasp only the energy consumption patterns of the energy consumers with different energy consumption scales through the standardization.

For example, the energy prediction device 100 may standardize the daily energy consumption patterns by use of the standardization technique to simultaneously consider the energy consumers with different energy consumption scales in the same cluster.

The energy prediction device 100 utilizes the standardization technique that utilizes a standard deviation and an average. The energy prediction device 100 may utilize a weekly average and standard deviation when clustering the weekly period energy consumption patterns, and may utilize a daily average and standard deviation when clustering the daily energy consumption patterns.

The energy prediction device 100 may normalize the energy consumption data through Equation 1.

$$\hat{X} = ( X - {μ}_{X} ) / {σ}_{X} \qquad [ Equation 1 ]$$

Here, \hat{X} represents standardized data, X represents original data before standardization, μ_{X} represents an average of X, and σ_{X} represents a standard deviation of X.

The energy prediction device 100 may set the optimal number of clusters before the clustering (step S420).

The energy prediction device 100 may set the optimal number of clusters by use of the AIC.

The AIC is an information criterion or index used to evaluate a relative quality of a statistical model. A balance between an ability of a statistical model to explain data and a complexity of the model may be measured with the AIC.

The AIC may be defined by Equation 2.

$$AIC = 2 k - log L \qquad [ Equation 2 ]$$

Here, k represents the number of estimated parameters, and L represents a model likelihood.

The AIC considers a trade-off between a fitness of the model and the complexity of the model. A lower AIC indicates a better-fitting model. When comparing multiple models by use of the AIC, the model with the lowest AIC is considered to be the best model at explaining the data.

That is, the energy prediction device 100 may be configured to determine that the lower the AIC, the more suitable the number of clusters is.

The energy prediction device 100 may cluster the weekly period energy consumption patterns (step S430).

The energy prediction device 100 may perform clustering by utilizing the standardized weekly energy consumption patterns (the weekly period energy consumption patterns) and the optimal number of clusters.

That is, the energy prediction device 100 may cluster similar weekly energy consumption patterns into the same cluster.

The energy prediction device 100 may perform clustering by utilizing a Gaussian mixture model (GMM) based on the standardized weekly energy consumption patterns and the optimal number of clusters.

The energy prediction device 100 may extract the weekly period energy consumption patterns of the energy consumers, measure a similarity between the extracted weekly period energy consumption patterns, and cluster the energy consumers based on the measured similarity.

The energy prediction device 100 may train the prediction model based on the daily period energy consumption patterns for each cluster (step S440).

The energy prediction device 100 may classify the daily energy consumption patterns of the energy consumers in each cluster, distinguish between the holiday energy consumption pattern and the weekday energy consumption pattern, and train the energy prediction model based on the classified daily energy consumption patterns.

The energy prediction device 100 may train the energy prediction model based on the energy consumption data of the individual energy consumers and the daily energy consumption patterns of the energy consumers in the same cluster.

The energy prediction model 100 may train the energy prediction model by use of at least one of the SVR model, the artificial neural network MLP model, or the stacked (Light-GBM-XGBoost-MLP Stacked) model.

The energy prediction device 100 may train the energy prediction model by utilizing past energy consumption amount data of the clustered energy consumers.

The energy prediction device 100 may utilize standardized daily energy consumption patterns as an input for training to utilize the energy consumers with different energy consumption scales within the same cluster together.

The energy prediction device 100 may be configured to predict the energy consumption amount by use of the trained energy prediction model (step S450).

The energy prediction device 100 may perform energy consumption prediction for the energy consumers corresponding to each cluster by use of the trained energy prediction model.

According to an exemplary embodiment of the present disclosure, the energy prediction device 100 does not know statistics (the average and standard deviation) of the energy consumption amount of a date for which prediction is performed, and thus, a standardized predicted consumption amount may be restored by utilizing statistics of the energy consumption amount of a previous day to perform the final energy prediction.

The energy prediction device 100 may obtain a final predicted energy amount by use of Equation 3.

$$\tilde{Y} = \hat{Y} {σ}_{X} + {μ}_{X} \qquad [ Equation 3 ]$$

Here, \tilde{Y} represents the final predicted energy amount, Ŷ represents a standardized predicted energy amount generated from the energy prediction model, μ_{X} represents an average of X, and σ_{X} represents a standard deviation of X.

The energy prediction device 100 may perform accurate energy prediction by use of minimum energy data (that is, for one week) with which the cluster of the energy consumption pattern of the energy consumer may be classified even for a new energy consumer in the energy consumption complex.

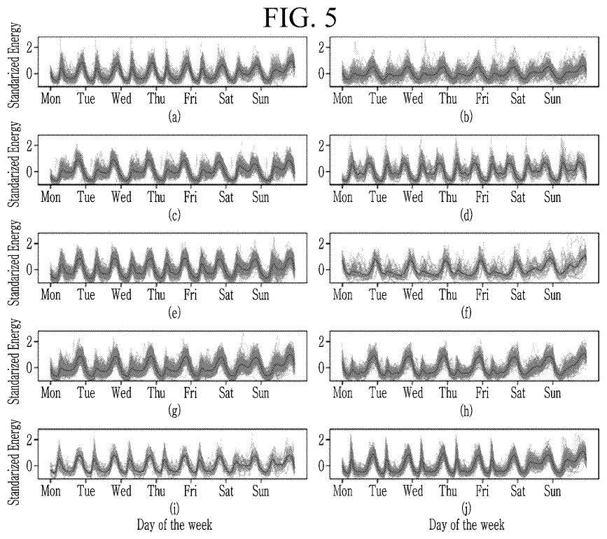

FIG. 5 is graphs showing a clustering result according to an exemplary embodiment of the present disclosure.

For example, FIG. 5 may show a result of clustering the weekly energy consumption patterns of an actual apartment complex in Korea.

Graphs (a) to (j) of FIG. 5 show standardized weekly period energy consumption amounts of different clusters, respectively. That is, Graphs (a) to (j) show a plurality of clusters, in which the energy consumers with similar weekly period energy consumption patterns belong to the same cluster.

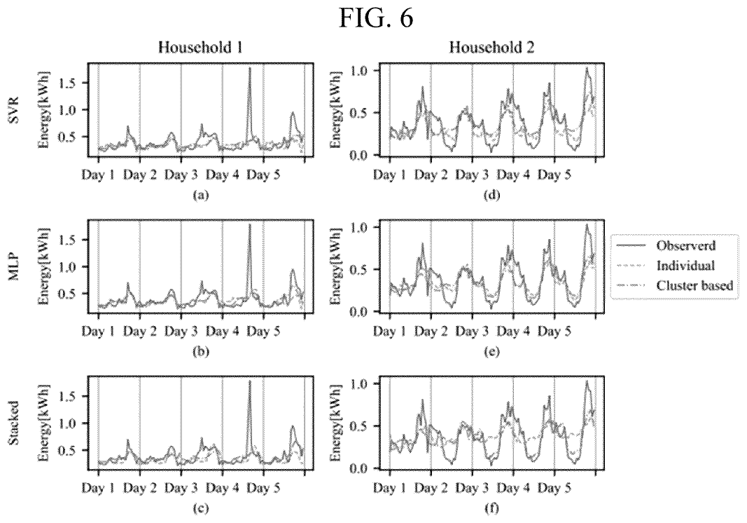

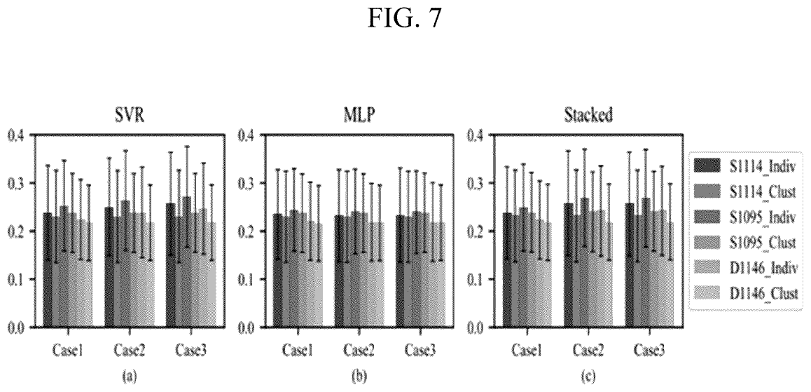

FIG. 6 and FIG. 7 are graphs showing prediction results obtained using the energy prediction method according to an exemplary embodiment of the present disclosure.

FIG. 6 is graphs showing energy [kWh] of individual households (Households 1 and 2) predicted by the energy prediction model generated using the SVR prediction model, the MLP prediction model, and the stacked (Light GBM-XGB-MLP Staked) prediction model, respectively, for Day 1 to Day 5. For example, Graph (a) shows an energy prediction result obtained using the SVR prediction model for Household 1.

Prediction results of the energy prediction model using the multiple period clustering according to an exemplary embodiment of the present disclosure are shown as a cluster-based result and an individual-based result.

It may be seen that prediction results of Graphs (a) to (f) of FIG. 6 are similar to observed energy.

FIG. 7 shows prediction result statistics of Cases 1 to 3 when the respective prediction models are used. It may be seen that the cluster-based prediction result and the individual-based prediction result are constant in Cases 1 to 3.

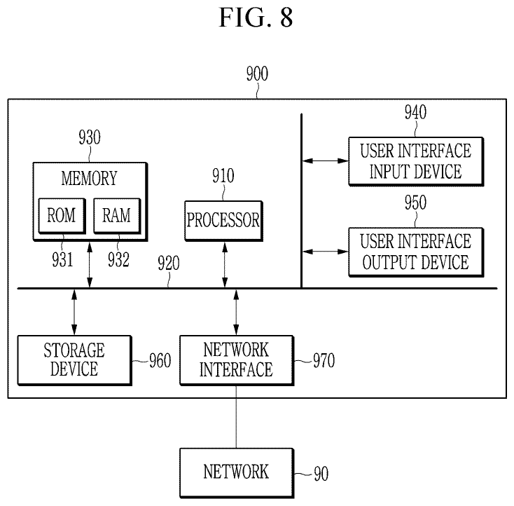

FIG. 8 is a diagram for describing a computing device according to an exemplary embodiment of the present disclosure.

Referring to FIG. 8, the energy prediction device and the energy prediction method according to the exemplary embodiments of the present disclosure may be implemented using a computing device 900.

The computing device 900 may include at least one of a processor 910, a memory 930, a user interface input device 940, a user interface output device 950, and a storage device 960 that communicate with one another via a bus 920. The computing device 900 may further include a network interface 970 that is electrically connected to a network 90. The network interface 970 may transmit or receive a signal with another entity via the network 90.

The processor 910 may be implemented in various types such as a micro controller unit (MCU), an application processor (AP), a central processing unit (CPU), a graphics processing unit (GPU), and a neural processing unit (NPU), and may be any semiconductor device that executes an instruction stored in the memory 930 or the storage device 960. The processor 910 may be configured to implement the functions and methods described above with reference to FIGS. 1 to 7.

The memory 930 and the storage device 960 may include various types of volatile or nonvolatile storage media. For example, the memory 930 may include a read only memory (ROM) 931 and a random access memory (RAM) 932. In an exemplary embodiment of the present disclosure, the memory 930 may be positioned inside or outside the processor 910, and may be connected to the processor 910 through various means that are already known.

In various exemplary embodiments of the present disclosure, at least some of the components or functions of the energy prediction device and the energy prediction method according to the exemplary embodiments of the present disclosure may be implemented as a program or software which is executed on the computing device 900, and the program or software may be stored in a computer-readable medium.

In various exemplary embodiments of the present disclosure, at least some of the components or functions of the energy prediction device and the energy prediction method according to the exemplary embodiments of the present disclosure may be implemented using hardware or circuitry of the computing device 900, or may be implemented as separate hardware or circuitry which may be electrically connected to the computing device 900.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An energy prediction apparatus comprising:
a clustering unit clustering energy consumers with similar measured weekly period energy consumption patterns by extracting weekly period energy consumption patterns of the energy consumers and measuring a similarity between the extracted weekly period energy consumption patterns; and
a training unit classifying daily energy consumption patterns of the energy consumers in each cluster and generating and training an energy prediction model for predicting an energy consumption amount through machine learning based on the classified daily energy consumption patterns of the energy consumers in each cluster.

2. The energy prediction apparatus of claim 1, further including:
a prediction unit predicting the energy consumption amount of each of the energy consumers based on individual energy consumption data of the energy consumers and energy consumption patterns of the energy consumers in the cluster by use of the energy prediction model.

3. The energy prediction apparatus of claim 1, wherein the training unit trains the energy prediction model by distinguishing between a holiday energy consumption pattern and a weekday energy consumption pattern in the daily energy consumption patterns.

4. The energy prediction apparatus of claim 1, wherein the training unit trains the energy prediction model based on individual energy consumption data of the energy consumers and the daily energy consumption patterns of the energy consumers in a same cluster.

5. The energy prediction apparatus of claim 4, wherein the training unit standardizes the daily energy consumption patterns by use of a standardization technique to simultaneously consider the energy consumers with different energy consumption scales in the same cluster.

6. The energy prediction apparatus of claim 1, wherein the energy prediction model includes a support vector regression (SVR) model, an artificial neural network multi-layer perceptron (MLP) model, and a stacked (Light-GBM-XGBoost-MLP Stacked) model.

7. The energy prediction apparatus of claim 1, wherein the clustering unit utilizes an Akaike information criterion (AIC) to set an optimal number of clusters.

8. The energy prediction apparatus of claim 1, further including:
a preprocessing unit extracting abnormal data which is uncommon for energy consumption data, generating an index of each of a day and a week including the extracted abnormal data, and excluding the day and the week including the indices from the clustering and the training.

9. An energy prediction apparatus predicting energy consumption amounts of energy consumers by use of:
an energy prediction model trained based on individual energy consumption data of the energy consumers, and
a daily energy consumption pattern of each of the energy consumers in a cluster generated based on a similarity between weekly period energy consumption patterns of the energy consumers.

10. An energy prediction method comprising:
clustering, by a processor, energy consumers with similar measured weekly period energy consumption patterns by extracting weekly period energy consumption patterns of energy consumers and measuring a similarity between the extracted weekly period energy consumption patterns; and
classifying, by the processor, daily energy consumption patterns of the energy consumers in each cluster and generating and training an energy prediction model for predicting energy consumption amounts of the energy consumers through machine learning based on the classified daily energy consumption patterns.

11. The energy prediction method of claim 10, further including:
predicting, by the processor, the energy consumption amount of each of the energy consumers based on individual energy consumption data of the energy consumers and energy consumption patterns of the energy consumers in the cluster by use of the energy prediction model.

12. The energy prediction method of claim 10, wherein the generating of the energy prediction model includes training the energy prediction model by distinguishing between a holiday energy consumption pattern and a weekday energy consumption pattern in the daily energy consumption patterns.

13. The energy prediction method of claim 10, wherein the training of the energy prediction model includes training the energy prediction model based on individual energy consumption data of the energy consumers and the daily energy consumption patterns of the energy consumers in a same cluster.

14. The energy prediction method of claim 13, wherein the training of the energy prediction model includes standardizing the daily energy consumption patterns by use of a standardization technique to simultaneously consider the energy consumers with different energy consumption scales in the same cluster.

15. The energy prediction method of claim 10, wherein the training of the energy prediction model includes training the energy prediction model by use of at least one of a support vector regression (SVR) model, an artificial neural network multi-layer perceptron (MLP) model, or a stacked (Light-GBM-XGBoost-MLP Stacked) model.

16. The energy prediction method of claim 10, wherein the clustering includes using an Akaike information criterion (AIC) to set an optimal number of clusters.

17. The energy prediction method of claim 10, further including:
performing, by the processor, preprocessing of extracting abnormal data which is uncommon for energy consumption data, generating an index of each of a day and a week including the extracted abnormal data, and excluding the day and the week including the indices from the clustering and the training.
